(19) United States
(12) Patent Application Publication
(10) Pub. No.: US 2020/0118046 A1
(43) Pub. Date: Apr. 16, 2020

(54) REAL-TIME RATE FILTERING SYSTEM

(71) Applicant: HRS GmbH, Cologne (DE)

(72) Inventors: Tobias Ragge, Cologne (DE); Martin Biermann, Berlin (DE)

(21) Appl. No.: 16/520,722

(22) Filed: Jul. 24, 2019

Related U.S. Application Data
(60) Provisional application No. 62/714,328, filed on Aug. 3, 2018.
(60) Provisional application No. 62/713,398, filed on Aug. 1, 2018.

(51) Int. Cl. G06Q 10/02; G06Q 30/06; G06F 16/215

(52) U.S. Cl. CPC G06Q 10/02; G06F 16/215; G06Q 30/0625

(57) ABSTRACT

A system and machine-implemented method query offers from multiple supplier systems and filter inaccurate negotiated rates in reservation systems in real-time. A user makes a request to an offer search and booking system for travel products. The system then queries multiple supplier systems for available rates for the given search parameters provided by the user. Available offers are responded. A determination is made if two available offers represent the same offer. In case an offer duplicates another one, it is filtered out from the response. Another determination is made if an available offer is based on prior negotiations with the supplier. In case that a supplied negotiated rate does not match the contractually agreed attributes, it is filtered out from the response and prohibited from being consumed.

### CROSS REFERENCE TO RELATED APPLICATIONS

This application claims the benefit of priority under 35 USC 119(e) of U.S. provisional application No. 62/713,398, filed on Aug. 1, 2018, and U.S. provisional application No. 62/714,328, filed on Aug. 3, 2018.

### TECHNICAL FIELD

The present disclosure generally relates to travel distribution systems and travel reservation systems, in particular an integrated real-time rate multi-sourcing and rate filtering system.

### BACKGROUND

Rates comprise a reference to one or more travel products, related additional services or amenities, and a negotiated price, price span, discount or voucher. Travel products can be for example a hotel accommodation, a private or peer-to-peer accommodation in the sharing economy, an airline ticket, a car rental, a meeting room with or without meeting equipment, meals, activities, tours, ride shares, or other travel segments.

Rates are made available to travelers in the form of offers (in the following ‘offers’). An offer is comprised of a rate, a reservation period, period of validity and eventually further information, for example customer eligibility to use the offer or allowed payment forms to pay for the offered contents.

An offered price can be further detailed in attributes of net values, taxes, fees and gross values.

Offers are provided by a supplier through distribution systems for travelers to book them when planning a travel. Offers based on negotiated rates (in the following ‘negotiated offer’) can be made identifiable as such by a label or agreed identifier, for example, a rate access code.

Travel suppliers (in the following ‘suppliers’) can be direct producers or intermediary resellers or other kinds of distributors of travel products.

Some corporations, governments, non-government organization, associations, travel management companies and online travel agencies (in the following ‘consumer’) negotiate rates with travel suppliers for the travelers in an organization, its subsidiaries or related organizations and travelers. The outcome of the negotiations are negotiated rates. In some aspects negotiated rates are corporate rates, dynamic rates, chain discounts, chain-wide discounts, or any other form of a rate which attributes have been negotiated between the consumer and supplier.

Negotiated offers are considered correct, when their attributes match those of the underlying negotiated rates contractually agreed upon. Negotiated offers are incorrect, if any of their attributes does not match those of the underlying negotiated rates contractually agreed and therefore contain another, non-negotiated rate.

### SUMMARY

The disclosed subject matter relates to a machine-implemented method for retrieving offers from multiple supplier systems, de-duplicating multiple offers representing a same rate, and validating negotiated offers and classifying them in real-time to be correct or incorrect. In case a negotiated offer is incorrect, the method filters the offer and thereby prohibits the offer from being further distributed or bookable in a reservation system.

The disclosed subject matter further relates to a system for searching rate offers and making reservations for offers in an online booking tool or back office tool of a travel manager (hence referred to as ‘OBT’). An OBT provides a booking channel for a traveler to select offers for a travel and make a reservation for it in some connected reservation system (in the following ‘booking’). In some aspects, an OBT offers a search input form to take important information for the assumed travel, such as time of travel, origin and destination, number of persons traveling and further detailed attributes of the travel supporting the determination of offers to be provided by suppliers as a result to the search. The person searching for offers in an OBT and eventually making a reservation through such OBT is in the following referred to as a ‘booker’. Modern approaches to OBTs facilitate chat communication, voice activation mechanisms to fill those criteria of the search, or reservation automation systems making a booking on behalf of a booker.

The disclosed subject matter also relates to a system of one or more distribution systems that, eventually daisy-chained, are connected to an OBT providing offers for a specific search. Distribution systems can be global distribution systems (GDS), chain reservation systems (also computer reservation system, CRS), channel management systems (also ‘channel managers’), meta-search engines, or any other remote system providing a supplier the ability to distribute its offers into OBTs.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several embodiments of the subject technology are set forth in the following figures.

FIG. 1 illustrates an example network environment which can provide real-time rate multi-sourcing and rate filtering.

FIG. 2 illustrates an example of a client-server communication for real-time rate multi-sourcing and rate filtering.

FIG. 3 illustrates an example process by which real-time rate multi-sourcing is applied.

FIG. 4 illustrates an example process by which real-time rate filtering is applied.

### DETAILED DESCRIPTION OF ILLUSTRATIVE EMBODIMENTS

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

As mentioned above, some organizations negotiate travel products with suppliers. The outcome of the negotiations are negotiated rates. Upon finishing the negotiation, the supplier has to make available the negotiated rates in the form of offers as per the agreed terms for booking through its distribution systems so that a booker can search for them, select them when returned and book them in OBTs connected to the distribution systems.

The problem with this method is that the supplier may miss to provide negotiated rate attributes in the offers completely or provide attributes differently than they were agreed upon, when loading them into the distribution channels, or some involved system may manipulate the attributes. As a result, the booker may be provided with some negotiated offer which attributes may not comply with the negotiated terms. This may mean a deviation of the offer's price from the agreed value of the anticipated negotiated rate price. Hence the booker must be provided a method to identify incorrect negotiated offers and filter them from being bookable by the booker.

The subject technology provides for protecting the bookers from booking incorrect negotiated offers. A booker uses an OBT and searches for a travel product. When starting the search, the OBT forwards the request to a distribution system or sends a secondary request to that respectively. The content provider connects to a distribution system, and requests available offers as provided by suppliers. Those offers can be negotiated offers. Upon collecting adequate offers for the request, the distribution system first forwards the results to a real-time rate filtering system which analyzes each offer's attributes. In case the offer is a negotiated one, the real-time rate filtering system validates its attributes with corresponding negotiated rate contract data. If no contract data can be found or any attribute of the offer is missing or deviates from the attributes in the corresponding negotiated rate contract data, the real-time rate filtering system excludes the offer from the result list then being sent to the OBT for the booker to select offers from and eventually book them.

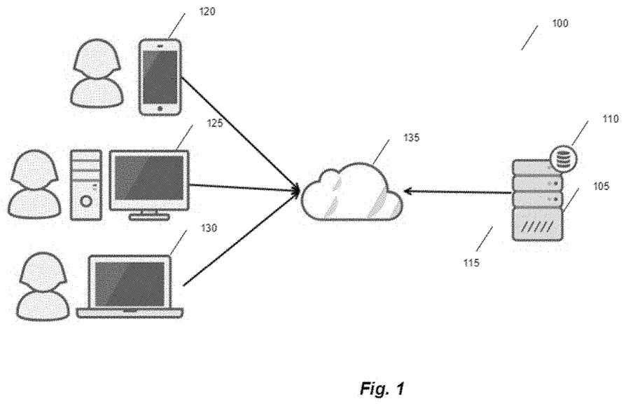

FIG. 1 illustrates an example network environment which can provide for real-time rate multi-sourcing and filtering. A network environment 100 contains computing devices 120, 125 and 130 and a computing system 115. Computing devices 120-130 and computing system 115 can communicate with each other through a network 135. Computing system 115 can include one or more computing devices 105 (e.g., one or more servers), respectively, and one or more computer-readable storage devices 110 (e.g., one or more databases), respectively.

Each of the computing devices 120-130 can represent various forms of processing devices. Example processing devices include a desktop computer, a laptop computer, a handheld computer, a personal digital assistant (PDA), a cellular phone, a smartphone, a tablet computer, or a combination of any of these data processing devices or other data processing devices.

Computing device 115 may be systems or devices having a processor, a memory, and communications capability for providing content to the electronic devices. In some example aspects, server 115 can be single computing devices, for example, a computer server. In other embodiments, server 115 can represent more than one computing device working together to perform the actions of a server computer (e.g., cloud computing). Further, computing devices 105 can represent various forms of servers including, but not limited to a web server, an application server, a proxy server, a network server, or a server farm.

In some aspects, the network environment 100 can be a distributed client/server system that may span one or more networks, for example, network 135. Network 135 can be a computer network, for example, a local area network (LAN), wide area network (WAN), the Internet, a cellular network, a WiFi network, or a combination thereof connecting any number of mobile clients, fixed clients, and servers. Further, the network 135 can include, but is not limited to, any one or more of the following network topologies, including a bus network, a star network, a ring network, a mesh network, a star-bus network, tree or hierarchical network, and the like. In some aspects, communication between each client (e.g., computing devices 120-130) and server (e.g., server 115) can occur via a virtual private network (VPN), Secure Shell (SSH) tunnel, or other secure network connection. In some aspects, network 135 may further include a corporate network (e.g., intranet) and one or more wireless access points.

In some examples, aspects any of the computing devices 120-130 transmits a request for offers to server 115 and server 115 receives the request. Server 115 obtains available offers for the request. Server 115 compares offers retrieved to be duplicated. Server 115 accesses a database of negotiated rate contract data to validate the retrieved offers against.

In case server 115 identifies some offers to be duplicated, server 115 removes duplicate offers from the list of obtained offers.

In case server 115 identifies some offers to be negotiated offers but incorrect, server 115 removes those offers from the list of obtained offers, before server 115 returns the list of retrieved offers to the computing device (e.g., any of 120-130).

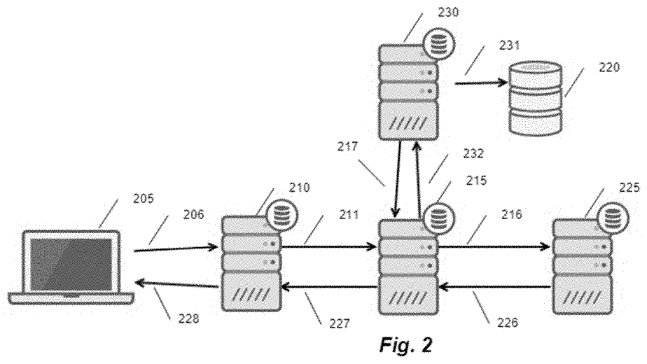

FIG. 2 illustrates an example of a client-server communication featuring real-time rate filtering. In the example, communication between a computing device 205 (e.g., any of computing devices 120-130) and a server 210 (e.g., server 115) over a network (e.g., network 135) is illustrated. In the example, server 210 further communicates over a network (e.g., network 135) with another computing system 215, which also communicates over a network (e.g., network 135) with another computing system 225. Computing system 215 communicates over a network (e.g., network 135) with another computing system 230, which communicates over a network (e.g., network 135) with a database system.

A software application or a web browser running on computing device 205 transmits a search request 206 for offers to computing system 210. In some aspects, computing system 210 can represent an OBT server to the OBT software application running or website running on computing device 205. Computing system 210 receives the request 206 and in consequence transmits another search request 211 to computing system 215. In some aspects, computing system 215 can represent a travel products aggregator system. Computing system 215 receives the search request 211 and in consequence transmits another search request 216 to computing system 225. In some aspects, the computing system 225 can represent a distribution system, for example a global distribution system for travel products, an online travel agency system, or specifically a hotel reservation system.

Computing system 225 responds to the search request 216 with a list of offers 226 computing system 225 has obtained based on the attributes given with the search request 216.

In the example, computing system 215 (e.g. an online travel agency reservation system) receives response 226 containing available offers from the computing system 225 (e.g. a hotel chain reservation system). Computing system 215 forwards the list received from request 216 in request 232 to computing system 230, which represents a real-time rate multi-sourcing and rate filtering system. In some aspects, computing system 215 can further manipulate the list from the representation received in response 226 to request 232.

Computing system 230 receives request 232 and compares each offer in the list received in request 232 with each other.

In case a duplicate offer in request 232 is identified, computing system 230 excludes it from the list from request 232.

Computation system 230 receives request 232 and loads negotiated rate contract data with request 231 from negotiated rate contracts database 220. Computing system 230 analyzes the offers received with request 232 and validates each contained offer with negotiated rate contract data loaded with request 231.

In case some negotiated offer contained in request 232 is classified as incorrect, computing system 230 excludes it from the list from request 232. When computing system 230 has sufficiently validated the offers received in request 232, it transmits the list of non-filtered offers in response 217 back to computing system 215. Computing system 215 then returns the list received in response 217 to computing system 210, in some aspects representing an OBT server. In some aspects, computing system 230 can further manipulate the list from the representation received in request 232 to response 217 and computing system 215 can further manipulate the list from the representation received in response 217 to response 227.

Computing system 210 transmits the list of validated offers in response 228 to the software application or web browser running on computing device 205.

In some aspects, requests 206, 211, 216, 232 and responses 216, 226, 227 and 228 can be exchanged in synchronous or asynchronous request/response communication.

In some example (not shown), servers 210, 215 and 215 can be composed into one or more servers combining each of their individual capabilities. In some aspects can a software application or web browser running on computing device 205 or a computing system 215 contain a real-time rate multi-sourcing and rate filtering system 230 and negotiated rates database 220. In some aspects can an OBT server 210 contain a real-time rate multi-sourcing and rate filtering system 230. In some aspects can computing system 225 contain a real-time rate multi-sourcing and rate filtering system 230 and negotiated rates database 220. In some aspects another server (not shown) can contain an OBT server 210, a real-time rate multi-sourcing and rate filtering system 230 with negotiated rates database 220 and a distribution system 225.

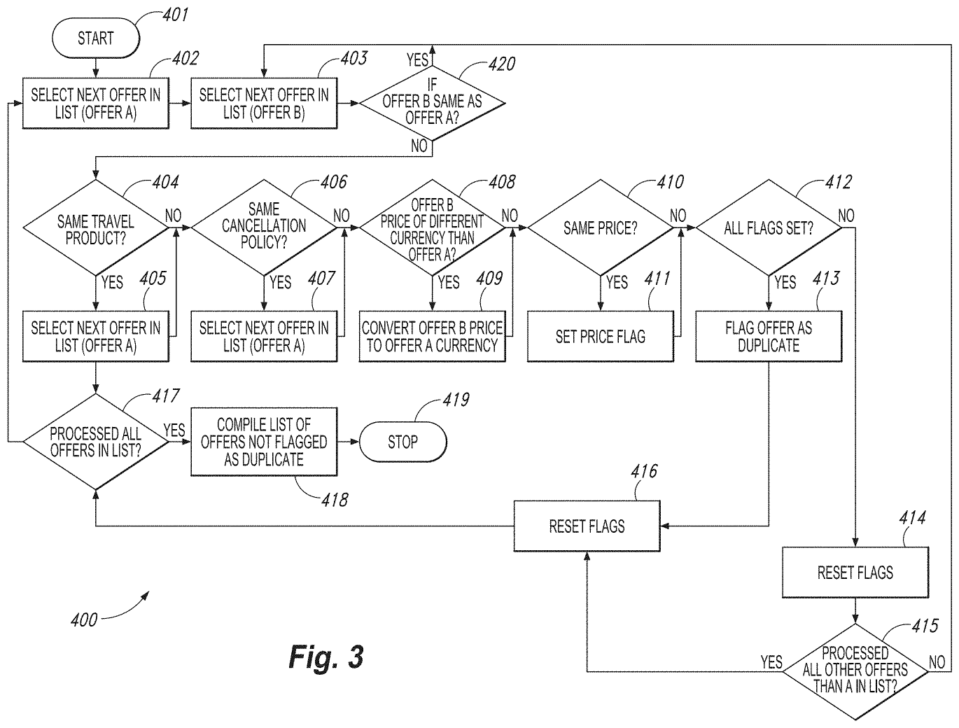

FIG. 3 illustrates an example process 400 by which real-time rate multi-sourcing is executed on computation system 230, eventually representing a real-time rate multi-sourcing system. In start block 401 the list of product offers in request 232 is received before iterated over in 402. For each iterated offer (hence referred to as “offer A”) in 402 the list of offers is iterated over again in a sub-routine in 403, so that each offer in the list is compared with each other throughout the process. Each offer in the sub-routine iteration in step 403 (hence referred to as “offer B”) is checked in step 420 whether it is the same as offer A. In case offer B is not the same as offer A in 420, the process progresses to step 404.

In case offer B is the same as offer A in 420, the next offer in the list is selected in 403.

In 404 it is checked whether offers A and B contain the same travel product and its contained properties, for example a superior hotel room category with included breakfast and parking. In case offers A and B contain different travel products as compared in 403, the process progresses to step 406.

In case both offers A and B contain the same travel product as compared in 403, a memory flag is set in 405, before progressing to step 406.

In 406 it is checked whether offer A contains the same cancellation policy as offer B. In case offer A contains a different cancellation policy as offer B in 406, the process progresses to step 408.

In case offer A contains the same cancellation policy as offer B in 406, a memory flag is set in 407, before progressing to step 408.

In 407 it is checked whether the price in offer B is of the same currency as the price in offer A. In case the currency of offer B is identical to the currency of offer A in 407, the process progresses to step 410.

In case the currency of offer B differs from the currency of offer A in 407, the price of offer B is converted into the currency of offer A in 409, before step 410 is triggered.

In 410 it is checked whether the price of offer B, or when converted in 409 the converted price of offer B, is the same as the price of offer A. In case the prices are not the same in 410, the process progresses to step 412.

In case the prices of offers A and B are the same in 410, a memory flag is set in 411, before progressing to step 412.

In step 412 it is checked whether all memory flags from 405, 407 and 411 are set. In case any flag is not set, the process progresses to step 414.

In case all flags from 405, 407 and 411 are set in 412, offer A is flagged as duplicate in 413, before progressing to step 416.

In 414 all memory flags from 405, 407 and 411 are reset, before progressing to step 415.

In 415 it is checked whether all offers in the list where iterated over in the sub-routine. In case not all offers where processed in the sub-routine, the process progresses to step 403.

In case all offers where processed in the sub-routine in 415, the process progresses to step 416.

In 416 all memory flags from 405, 407 and 411 are reset, before progressing to step 417.

In 417 it is checked whether all offers in the list where processed to determine whether they are considered a duplicate. In case not all offers from that list where processed, the process progresses to step 402.

In case all offers in the list of request 232 where processed in 417, the process progresses to step 418 in which the list all offers which were not labeled as duplicate in the process 400 are compiled into a list, before being returned in the stop block 419 to process 300. In some aspects, instead of compiling a new list of offers not labelled duplicate the process is set up in a way to remove those offers labelled duplicate from the list received in 401 before the list is returned in the stop block 419. In some aspects, the process is set up in a way to remove offers identified as duplicate in 412 from the list iterated over in 402 instead of labelling them in 413.

In some aspects, the steps in the process of real-time rate multi-sourcing in 400 are executed in different order or some of these steps may be skipped. In some aspects the steps in the process 400 may be amended by further steps of validation based on the offer's attributes available by the type of travel product. In some aspects the steps in the process 400 may be executed in parallel.

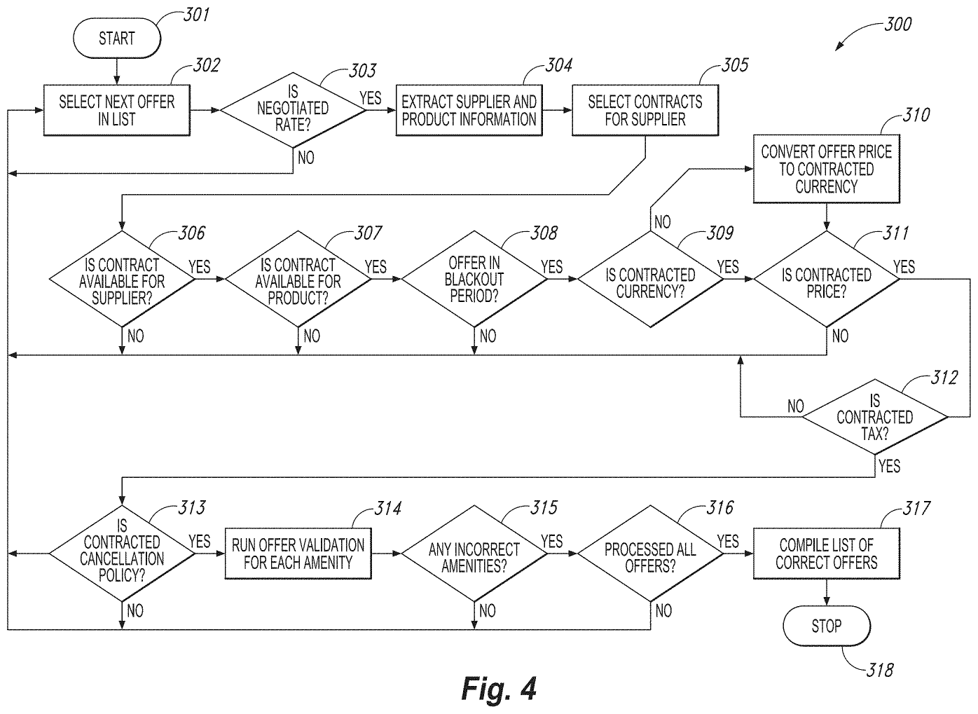

FIG. 4 illustrates an example process by which real-time rate filtering is executed on computation system 230, eventually representing a real-time rate filtering system. In start block 301 computation system 230 receives the list of product offers from process 400 in step 419 and iterates over each offer continuing in 302. The offer is checked to be a negotiated offer in 303. In case the offer is not a negotiated offer, the offer is classified correct and the next offer is loaded for validation in step 302.

In case the offer checked in 303 is a negotiated offer, the supplier identifier and product identification data is extracted from the offer in 304. In some aspects, product identification data can be a unique identifier or a tuple of identifying attributes, for example a hotel room category. Given the list of negotiated rate contract data retrieved in request 231, the corresponding contract data is chosen from the contract data list for the given supplier identifier and product identification data in 305.

In case no contract data was found for the given supplier identifier in 306, or some contract data was found for the given supplier identifier, but not for the given product identification data in 307, the offer is classified as an incorrect rate and the next offer is loaded for validation in step 302.

In case contract data was found for the given supplier identifier and product identification data in 306 and 307, the contract data is checked for agreed blackout periods which are validated against the offer's period in 308. In case the offer period falls into an agreed blackout period, the offer is classified as an incorrect rate and the next offer is loaded for validation in step 302.

In case there are no agreed blackout periods or the offer period doesn't fall into an agreed blackout period in 308, the offer's currency is validated against the agreed currency in the contract data in 309.

In case the offer's currency differs from the currency agreed in the contract data in 309, the offer's price is converted into the currency of the contract data in 310, before step 311 is triggered.

In case the offer's currency is the same as the currency agreed in the contract data in 309 or was converted in step 310, the resulting price of the offer is compared to the price in the contract data in 311. In case the offer's price was converted in 310, a tolerance can be applied to capture currency fluctuation. In case the offer price or converted offer price including the tolerance is not the same as agreed in the contract data in 311, the offer is classified as incorrect and the next offer is loaded for validation in step 302.

In case the offer's price or converted offer's price including the tolerance is the same as agreed in the contract data in 311, the offer's tax percentage is validated against the agreed tax in the contract data in 312. In case the offer's tax is not the same as agreed in the contract data, the offer is classified as an incorrect rate and the next offer is loaded for validation in step 302.

In case the offer's tax is the same as agreed in the contract data in 312, the offer's cancellation policy is validated against the agreed cancellation policy in the contract data in 313. In case the offer's cancellation policy is not the same as agreed in the contract data, the offer is classified as an incorrect rate and the next offer is loaded for validation in step 302.

In case the offer's cancellation policy is the same as agreed in the contract data in 313, the offer's amenities are extracted in 314 and are iterated as the actual offer starting in 302.

In case any of the offer's amenities is classified incorrect in 315, the offer is classified as an incorrect rate and the next offer is loaded for validation in step 302.

In case none of the offer's amenities is classified incorrect in 315, the offer is classified correct and it is checked whether there are further offers to be validated in 316. If there are further offers are to be validated in the list, the next offer is loaded for validation in step 302.

In case there is no further offer in the list to be validated in 316, a list of all offers classified correct is compiled in 317, before being returned in the stop block 318 in response 217 transmitted from computation system 230 to computation system 215.

In some aspects, the steps in the process of real-time rate filtering in 300 are executed in different order or some of these steps may be skipped. In some aspects the steps in the process 300 may be amended by further steps of validation based on the offer's attributes available by the type of travel product the agreed attributes in the contract data. In some aspects the steps in the process 300 may be executed in parallel.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

What is claimed:

1. A machine-implemented method of real-time rate multi-sourcing and rate filtering, the method comprising:
a request from a client computing device to a computing system to provide a list of offers;
retrieving offers from one or more connected supplier systems,
validating any offer returned to be duplicated and removing those duplicated offers,
validating any offer, when being a negotiated offer, against contract terms and removing offers from that list being classified incorrect; and
transmitting a list of non-duplicated and correct offers back to the client requesting computing device.

2. The method of claim 1, wherein an OBT applies real-time rate multi-sourcing and rate filtering.

3. The method of claim 1, wherein a distribution system applies real-time rate multi-sourcing and rate filtering.

4. The method of claim 1, wherein a user is presented with non-duplicated, multi-sourced offers and correct negotiated offers in an OBT.

5. A system for real-time rate multi-sourcing and rate filtering, the system comprising: client requesting computing devices, one or more computing systems, a database containing negotiated rates contract data.

6. The system of claim 5, wherein a client requesting computing device, transmits a request to a computing system.

7. The system of claim 5, wherein a computing system requests offers from another computing system.

8. The system of claim 5, wherein a computing system requests validation of an offers list from another computing system.

9. The system of claim 5, wherein a computing system validates offers and removed duplicate offers from an offers list.

10. The system of claim 5, wherein a computing system retrieves negotiated rate contract data from a database.

11. The system of claim 5, wherein a computing system validates offers and classifies them and their amenities to be correct or incorrect negotiated offers.

12. The system of claim 5, wherein a client requesting computing device, is returned a list of de-duplicated and correct negotiated offers.

13. The system of claim 5, which can contain OBT computation systems, travel content aggregator computation systems, distribution systems or any composition of those within one computation system (e.g. an OBT computation system also being an aggregator computation system or an aggregator system also being a distribution system).

14. A process for real-time rate multi-sourcing, the process comprising:
the iteration through a list of one or more offers;
the classification of duplicate offers;
the compilation of a list of non-duplicated offers.

15. A process for real-time rate filtering, the process comprising:
the iteration through a list of one or more offers;
the identification of negotiated and non-negotiated offers;
steps to validate an offer against negotiated rate contract data consisting of any of supplier identification, products identifications, blackout time period, offer amenities, currency, price, tax and cancellation policy;
the classification of some offers to be correct or incorrect;
the classification some offer amenity to be correct or incorrect following the same process; and
the compilation of a list of correct offers.

16. The process of claim 14, wherein offers in a list are analyzed and an offer classified as being a duplicate when it contains the same travel product and amenities as another offer at the same price and with the same cancellation policy.

17. The process of claim 14, wherein an offer price is converted to another offer's currency.

18. The process of claim 14, wherein is compiled a list of non-duplicated offers.

19. The process of claim 15, wherein contractual data on negotiated rates is used to validate and classify offers in real-time.

20. The process of claim 15, wherein offers are classified incorrect when the offer supplier is not contracted, when the product is not contracted, when a contracted blackout period overlaps with an offer period, when a contracted price doesn't match the offer price, or a contracted tax doesn't match the offer tax, or the cancellation policy doesn't match the contracted cancellation policy.

21. The process of claim 15, wherein an offer price is converted to a contracted currency.

22. The process of claim 15, wherein any offer attribute can be validated in following the parts of the process.

23. The process of claim 15, wherein is compiled a list of correct offers.
